(19) United States
(12) Patent Application Publication
(10) Pub. No.: US 2023/0239237 A1
(43) Pub. Date: Jul. 27, 2023

(54) SERVICE DISCOVERY METHOD FOR NETWORKS WITH MULTICAST RESTRICTIONS

(71) Applicant: Dell Products L.P., Round Rock, TX (US)

(72) Inventors: Zhuo ZHANG, Shanghai (CN); Kai ZHOU, Shanghai (CN); Zheng ZHANG, Shanghai (CN); Tianming ZHANG, Brighton, MA (US)

(73) Assignee: Dell Products L.P., Round Rock, TX (US)

(21) Appl. No.: 17/585,856

(22) Filed: Jan. 27, 2022

(51) Int. Cl. H04L 45/00; H04L 45/028

(52) U.S. Cl. CPC H04L 45/26; H04L 45/028; H04L 61/5092

(57) ABSTRACT

Disclosed service discovery methods include responding, by a node, to detecting a new connection to a switch port by performing new connection operations that include determining, using link-layer discovery protocol (LLDP) advertisements, a switch port number and self-assigning an IP address in accordance with a predetermined addressing protocol in which the self-assigned IP address is indicative of the switch port number. The IP address assigned to the node may indicate the node's switch port number. Disclosed methods may further include initiating a unicast discovery procedure to determine, via unicast messages exchanged between nodes connected to the switch, a switch port roster that lists or otherwise indicates nodes connected to the switch as well as their corresponding port numbers and services available from each node. The switch port roster may be distributed to each of the connected nodes. The unicast discovery procedure may be periodically launched to refresh and re-distribute the roster.

### TECHNICAL FIELD

The present disclosure relates to information handling system management and, particularly, discovery of available services and resources within a managed domain.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

System management capabilities are an important consideration for any significant deployment or platform of information handling systems. Within this field, service discovery may refer to the automatic detection of devices coupled to a network and services offered by such devices. Service discovery beneficially reduces efforts required by users and administrators to configure systems.

Service discovery protocols including, as an illustrative example, Zeroconf, may assume or require broadcast and/or multicast capability. For purposes of this disclosure, broadcast and multicast may be collectively referred to simply as multicast when distinctions between the two concepts is not significant. While highly useful in many applications, the use of multicast may be restricted for security reasons and especially in highly secure environments and applications. Accordingly, service discovery may, in at least some environments, require a solution that does not depend on multicasting.

### SUMMARY

In accordance with teachings disclosed herein, common problems associated with service discovery in a network with multicast restrictions are addressed by disclosed methods and systems, which respond to detecting a new connection between a node and a switch port by performing new connection operations including determining a switch port number comprising a port number of the switch port connected to the node. In some embodiments, determining the switch port number comprises obtaining link layer discovery protocol (LLDP) information from the switch port. An IP address is then assigned to the node, wherein the IP address includes or otherwise indicates the switch port number. A unicast discovery procedure is perform to discover, via unicast discovery messages, all nodes connected to the switch. A switch port roster, identifying all switch-connected nodes is distributed, in a series of unicast messages from one of the switch port, e.g., the node connected to the lowest switch port in the switch port roster. The switch port roster, indicative of all nodes connected to the switch and their respective switch ports, may be distributed to each of the switch-connected nodes.

The unicast discovery messages include, at least in part, unicast discovery messages from each switch-connected node to its nearest neighbor switch-connected node. The unicast discovery procedure may include sending, from a first node connected to a first switch port, a discovery message to a lower adjacent switch port. Responsive to detecting a second node connected to the lower adjacent switch port and determining that the second node is not included in the switch port roster, the second node may be added to the switch port roster and the second node may then send a discovery message to a next lower adjacent switch port. Responsive to detecting no node connected to the lower adjacent switch port, a discovery message may be sent from the first node to the next lower adjacent switch port.

If a node receives a discovery message from a sending node and determines, from the switch port roster, that the sending node is a new node, the unicast discovery procedure is restarted to capture the new node in the switch port roster. Responsive to a particular node detecting no further switch-connected nodes, i.e., the particular node is the lowest switch-connected node, the particular node then sends a series of unicast messages, indicative of the switch port roster, to each other node in the switch port roster. The node connected to the highest switch port may be identified as a starting node and the starting node may periodically perform the unicast discovery process to refresh and redistribute the switch port roster. Responsive to a switch-connected node not receiving a discovery message from a higher node during an interval exceeding a threshold duration, the node may be recognized as the highest node.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a graphical depiction of a unicast discovery procedure in accordance with disclosed teachings;

FIG. 2 is a graphical depiction of a unicast discovery procedure in which a node is newly inserted into an existing cluster;

FIG. 3 is a flow diagram illustrating a method for discovering nodes connected to a switch in accordance with disclosed teachings; and

FIG. 4 is a flow diagram illustrating a method for periodically re-discovering nodes connected to a switch in accordance with disclosed teachings; and

FIG. 5 is a block diagram illustrating an information handling system suitable for use in conjunction with disclosed systems and methods.

### DETAILED DESCRIPTION

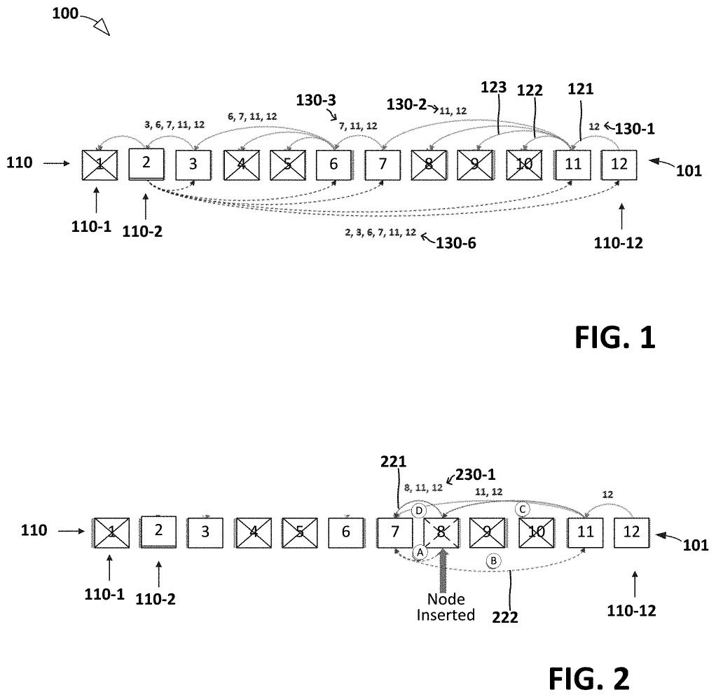

Exemplary embodiments and their advantages are best understood by reference to FIGS. 1-5, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Before referring specifically to the drawings, an overview of disclosed teachings is presented. Service discovery may be performed within an environment, including, but not restricted to, secure datacenter environments in which two or more nodes within a datacenter rack are connected to a top of rack (ToR) switch, but wherein the use of multicasting is restricted or prohibited with respect to at least some portion of the datacenter.

To perform service discovery in this environment, each node connected to a ToR switch determines the switch port number and assigns itself a static IP address reflecting the switch port number. Thereafter, higher nodes, i.e., nodes connected to higher-numbered switch ports, pass down the known endpoints to their lower nearest neighbor node. In this manner, the lowest or smallest node, i.e., the node connected to the lowest numbered switch port will receive information indicating all discovered nodes and their corresponding services and advertise this information to each of the other switch-connected nodes. Service discovery is thereby achieved with unicast traffic only.

Referring now to FIG. 1, a graphical representation of a disclosed unicast discovery procedure 100 associated with a ToR switch or, more simply, switch 101 is depicted. For the sake of clarity, the nodes and any connecting cables or the like are omitted from FIG. 1. The illustrated switch 101 includes a plurality of switch ports 110, including the twelves switch ports 110-1 through 110-12 explicitly depicted in FIG. 1. Other implementations may include more or fewer switch ports 110.

Each switch port 110 that has a node connected to it is indicated by the absence of an “X” across the switch port. Conversely, each switch port 110 not connected to a node is indicated by an “X” crossing the switch. Thus, switch ports 2, 3, 6, 7, 11, and 12 are each connected to a corresponding node while switch ports 1, 4, 5, 8, 9, and 10 are not connected to any node.

Disclosed unicast discovery procedures include an iterative sequence, beginning with the highest switch-connected node, i.e., the node connected to the highest-numbered switch port, in which each connected node discovers its lower nearest neighboring node by sending one or more unicast discovery messages to lower adjacent switch ports until a node-connected switch port is found or until there are no more neighboring switch ports remaining. Each time a lower nearest neighbor node is discovered, the discovered node is added to a switch port list. When the discovery cycle is complete, the switch port list identifies all connected nodes.

The node connected to switch port 12 (110-12) is the highest switch-connected node, so the discovery cycle begins with switch port 12. The switch port list (130-1) is initialized to include switch port 12 and the node connected to switch port 12 sends a unicast message 121 to its lower adjacent switch port, i.e., switch port 11. Because switch port 11 has a connected node, switch port 11 is added to the switch port roster (130-2) and the node connected to switch port 11, referred to herein as node 11 for the sake of brevity, is next to discover its lower nearest neighbor.

Node 11 begins the process of discovering its lower nearest neighbor by sending a discovery message 122 to its lower adjacent switch port, i.e., switch port 10. Because no node is connected to switch port 10, node 11 sends a second discovery message (123) to the next lower adjacent switch port, i.e., switch port 9. This process continues until node 11 discovers that node 7 is its lower nearest neighbor, at which point node 7 is added to the switch port roster (130-3). Node 7 then determines its lower nearest neighbor, i.e., node 6 and so on in like manner until node 2, the lowest connected node discovers that it has no lower neighbor, at which point node 2 recognizes that it is the lowest connected node, adds itself to the incoming switch port roster (130-5) to produce the final switch port roster 130-6. As the lowest switch-connected node, node 2 then sends, to every other switch-connected node, a unicast message identifying all of the connected endpoints/services

As depicted in FIG. 1, each switch-connected node is capable of addressing unicast messages to the applicable neighboring switches based on a predetermined protocol in which each switch-connected node assigns itself an IP address that indicates the applicable switch port. For example, when a node is first connected to switch 12, the node assigns itself an IPv4 (or IPv6 in some cases) address in which the lowest significant bits byte of the IP address contain or otherwise indicates the value 12.

FIG. 2 illustrates an example in which a node is inserted into a previously unoccupied switch port. Specifically, FIG. 2 illustrates a node inserted into previously unoccupied switch port 8. The change in status of switch port 8 is noted in FIG. 2 by the hashed “X” overlaying switch port 8.

As shown in FIG. 8, The insertion of a node into switch port 8 triggers a new connection sequence in which the unicast discovery process is initiated beginning at the newly inserted node. Accordingly, note 8 will begin this discovery sequence by sending a discover message (221)to its lowest adjacent switch port (port 7). When node 7 receives discovery message 221 from the newly inserted node at switch port eight, node seven will recognize, by referencing the last known switch port roster (not explicitly depicted in FIG. 2) that node 8 is a new node. Node seven will then restart the node discovery sequence by sending a message to its last known upper nearest neighbor. In the example illustrated in FIG. 2, node 11 was the last known upper neighbor of node 7 and, accordingly, node 7 messages (222) node 11 to restart discovery. Node 11 then discovers that newly inserted node 8 is now its lower nearest neighbor and adds node 8 to the switch port roster (230-1). Thus, when node 8 re-discovers node 7 as its lower nearest neighbor, the switch port roster is accurate.

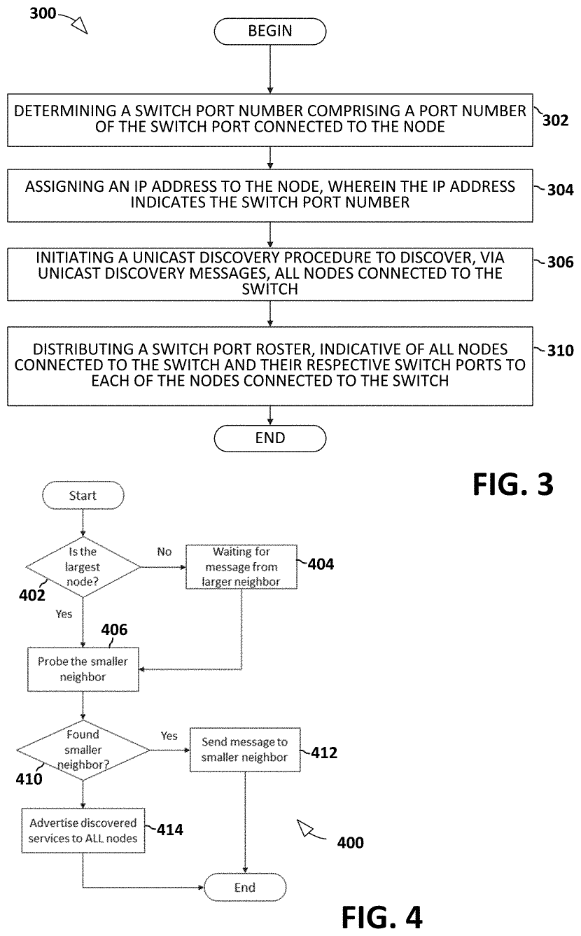

FIG. 3 illustrates a new connection method 300 performed in response to a new node being connected to the switch. The illustrated method 300, which may be performed by the newly connected node, includes determining (block 302) a switch port number comprising a port number of the switch port connected to the node. An IP address is then assigned (block 304) to the node, wherein the IP address indicates the switch port number. A unicast discovery procedure, such as the procedure described above with respect to FIG. 1 is initiated (block 306) by sending unicast discovery messages to discover all nodes connected to the switch. A switch port roster, indicative of all endpoints and services connected to the switch is then distributed (block 310), again using unicast messages, to each of the nodes connected to the switch.

FIG. 4 illustrates a method 400 that, in at least some embodiments, represents the ongoing procedure performed by each switch-connected node with respect to discovery. The illustrated method 400 begins with decision block 402, in which a switch-connected node determines whether it is the largest node, i.e., the node connected to the highest numbered switch port. If the node is the largest node, method 400 branches to block 406, in which the node probes for a smaller neighboring node, i.e., a node connected to smaller neighboring switch port. If, in block 402, the note determines that it is not the largest node, the illustrated method 400 branches to operation 404, in which the node waits for a discovery message from a neighboring larger node. When a message is received, the illustrated method branches to block 406. If no message is received from a larger neighboring node, the node becomes the largest node and re-starts method 400.

After a node probes it's smaller neighbor in block 406, method 400 determines (block 410), whether any smaller neighbors are present. If no smaller neighbors are present, method 400 branches to block 414, in which the node, having determined that it is the smallest node, advertises discovered nodes and services to all other switch-connected nodes. If, in block 410, a node discovers a smaller neighbor, the node sends (block 412), a discovery message to the smaller neighbor.

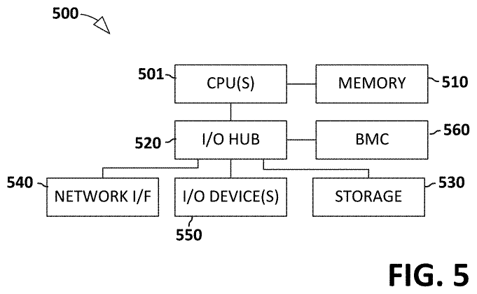

Referring now to FIG. 5, any one or more of the elements illustrated in FIG. 1 through FIG. 4 may be implemented as or within an information handling system exemplified by the information handling system 500 illustrated in FIG. 5. The illustrated information handling system includes one or more general purpose processors or central processing units (CPUs) 501 communicatively coupled to a memory resource 510 and to an input/output hub 520 to which various I/O resources and/or components are communicatively coupled. The I/O resources explicitly depicted in FIG. 5 include a network interface 540, commonly referred to as a NIC (network interface card), storage resources 530, and additional I/O devices, components, or resources 550 including as non-limiting examples, keyboards, mice, displays, printers, speakers, microphones, etc. The illustrated information handling system 500 includes a baseboard management controller (BMC) 560 providing, among other features and services, an out-of-band management resource which may be coupled to a management server (not depicted). In at least some embodiments, BMC 560 may manage information handling system 500 even when information handling system 500 is powered off or powered to a standby state. BMC 560 may include a processor, memory, an out-of-band network interface separate from and physically isolated from an in-band network interface of information handling system 500, and/or other embedded information handling resources. In certain embodiments, BMC 560 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
responsive to detecting a new connection between a node and a switch port, performing new connection operations, wherein the new connection operations include:
determining a switch port number comprising a port number of the switch port connected to the node;
assigning an IP address to the node, wherein the IP address indicates the switch port number;
initiating a unicast discovery procedure to discover, via unicast discovery messages, all nodes connected to the switch; and
distributing a switch port roster, indicative of all nodes connected to the switch and their respective switch ports to each of the nodes connected to the switch.

2. The method of claim 1, wherein determining the switch port number comprises obtaining link layer discovery protocol (LLDP) information from the switch port.

3. The method of claim 1, wherein the unicast discovery message include unicast discovery messages from each switch-connected node to its nearest neighbor node.

4. The method of claim 3, wherein the unicast discovery procedure includes:
sending, from a first node connected to a first switch port, a discovery message to a lower adjacent switch port;
responsive to detecting a second node connected to the lower adjacent switch port and determining that the second node is not included in the switch port roster:
adding the second node to the switch port roster; and
sending a second discovery message from the second node to a next lower adjacent switch port; and
responsive to detecting no node connected to the lower adjacent switch port, sending a discovery message from the first node to the next lower adjacent switch port.

5. The method of claim 4, wherein the unicast discovery procedure further includes:
responsive to receiving a discovery message from a sending node and determining, from the switch port roster, that the sending node is a new node, restarting the unicast discovery procedure to capture the new node in the switch port roster.

6. The method of claim 4, wherein the unicast discovery procedure further includes, responsive to a particular node detecting no further switch-connected nodes:
identifying the particular node as a lowest node; and
sending unicast messages, indicative of the switch port roster, from the lowest node to each other node in the switch port roster.

7. The method of claim 4, further comprising:
identifying a switch-connected node connected to a highest switch port as a starting node; and
periodically performing the unicast discovery process, beginning with the highest node, to refresh and redistribute the switch port roster.

8. The method of claim 7, further comprising:
responsive to a switch-connected node not receiving a discovery message from a higher node during an interval exceeding a threshold duration, identifying the switch-connected node as the highest node.

9. An information handling system, comprising:
a central processing unit (CPU); and
a memory, accessible to the processor, including processor executable instructions that, when executed by the CPU, cause the system to perform management operations comprising:
responsive to detecting a new connection between a node and a switch port, performing new connection operations, wherein the new connection operations include:
determining a switch port number comprising a port number of the switch port connected to the node;
assigning an IP address to the node, wherein the IP address indicates the switch port number;
initiating a unicast discovery procedure to discover, via unicast discovery messages, all nodes connected to the switch; and
distributing a switch port roster, indicative of all nodes connected to the switch and their respective switch ports to each of the nodes connected to the switch.

10. The information handling system of claim 9, wherein determining the switch port number comprises obtaining link layer discovery protocol (LLDP) information from the switch port.

11. The information handling system of claim 9, wherein the unicast discovery message include unicast discovery messages from each switch-connected node to its nearest neighbor node.

12. The information handling system of claim 11, wherein the unicast discovery procedure includes:
sending, from a first node connected to a first switch port, a discovery message to a lower adjacent switch port;
responsive to detecting a second node connected to the lower adjacent switch port and determining that the second node is not included in the switch port roster:
adding the second node to the switch port roster; and
sending a second discovery message from the second node to a next lower adjacent switch port; and
responsive to detecting no node connected to the lower adjacent switch port, sending a discovery message from the first node to the next lower adjacent switch port.

13. The information handling system of claim 12, wherein the unicast discovery procedure further includes:
responsive to receiving a discovery message from a sending node and determining, from the switch port roster, that the sending node is a new node, restarting the unicast discovery procedure to capture the new node in the switch port roster.

14. The information handling system of claim 12, wherein the unicast discovery procedure further includes, responsive to a particular node detecting no further switch-connected nodes:
identifying the particular node as a lowest node; and
sending unicast messages, indicative of the switch port roster, from the lowest node to each other node in the switch port roster.

15. The information handling system of claim 12, further comprising:
identifying a switch-connected node connected to a highest switch port as a starting node; and
periodically performing the unicast discovery process, beginning with the highest node, to refresh and redistribute the switch port roster.

16. The information handling system of claim 15, further comprising:
responsive to a switch-connected node not receiving a discovery message from a higher node during an interval exceeding a threshold duration, identifying the switch-connected node as the highest node.
